(19) United States
(12) Patent Application Publication
(10) Pub. No.: US 2026/0307612 A1
(43) Pub. Date: Oct. 8, 2026

(54) RESTRAINING DEVICE OF A SEAT UNIT

(71) Applicant: AUTOLIV DEVELOPMENT AB, Vargarda (SE)

(72) Inventors: Laurent HELLOT, La Feuillie (FR); Carole GAILHARD, Gournay-en-Bray (FR); Laurent LENGAIGNE, La Chaussée (FR); Julien HALGRIN, Doudeauville en Vexin (FR); Marc MARCHAND, LE VAUMAIN (FR); Frederic CHARPENTIER, Le Vauroux (FR); Damien RIBILLARD, Ernemont la Villette (FR)

(21) Appl. No.: 19/484,671

(22) PCT Filed: May 23, 2024
(86) PCT No.: PCT/EP2024/064240

§ 371 Date: Nov. 14, 2025

(30) Foreign Application Priority Data
May 25, 2023 (DE) 10 2023 113 736.0

(51) Int. Cl. B60R 21/231; B60R 21/2338

(52) U.S. Cl. CPC B60R 21/23138; B60R 21/2338; B60R 2021/23146; B60R 2021/23388

(57) ABSTRACT

A restraining device of a seat unit comprises an airbag having a side part enclosing a side chamber and being attached to a seatback of the seat unit, and a front part enclosing a front chamber and being attached to the side part. The front chamber and the side chamber are in fluid communication with one another. In the deployed state of the airbag, the side part extends from a rear end to a front end, and the front part extends from an outer end being connected to the side part to an inner end. In order to improve the restraining performance of the front part, a non-inflatable retraining element is provided.

The invention relates to a Restraining device of a seat unit according to the preamble of claim 1, to a restraining assembly comprising such a restraining device and an inflator according to claim 11 and to a seat unit comprising a vehicle seat and at least one such restraining assembly according to claim 12.

Almost every modern passenger car, van, or the like comprises at least two frontal airbags, one for the driver—the driver airbag—and one for the front-seated passenger—the passenger airbag—. These frontal airbags are attached to a structural part of the vehicle, usually the steering wheel or the instrument panel, such that they are supported by this structural element. It is further common to equip a vehicle seat with at least one side airbag which deploys from the seatback. In most of today's passenger cars, the frontal airbag and the side airbag are independent.

In order to be independent from a supporting structure of the vehicle (e.g. the steering wheel and the instrument panel) and/or to provide additional protection, combined side- and frontal airbags have been proposed which comprise a side part enclosing a side chamber and being attached to the seatback, and a front part enclosing a front chamber and being attached to the side part, wherein the front chamber is in fluid communication with the side chamber. The geometry is such that in the deployed state of the airbag, the side part extends from a rear end of the side part being attached to the seatback to a front end of the side part and from a lower end of the side part to an upper end of the side part, and the front part extends from an outer end of the front part being connected to the side part to an inner end of the front part, and from a lower end of the front part to an upper end. Or in other words: The deployed side part extends laterally from the person sitting in the vehicle seat and the front part is held by the side part (and filled via the side part) and is positioned essentially in front of the head of the person sitting in the vehicle seat or in front of the head and at least a part of the thorax.

Starting from this prior art, it is an object of the invention to improve such a restraining device comprising an airbag having a side part and a front part in such a way that its capability of protecting a person sitting in the vehicle seat is improved, especially in case of a frontal crash.

This task is solved by a restraining device having the features of claim 1. A restraining assembly further comprising an inflator is defined in claim 11 and a seat unit comprising a vehicle seat and at least one such restraining assembly is defined in claim 12.

It turned out that in cases in which no external support is provided, the front part of the airbag often tends to bent away in a swerving movement when hit by the head of the person to be protected, such that this person is not sufficiently protected in case of a frontal crash. In order to prevent this swerving movement, a non-inflatable retraining element is provided that extends from a first connection section being connected to the front part of the airbag to a second connection section being connected to at least one of the vehicle seat and a part of the restraining device located rear of the front part when the airbag is in its deployed state. This non-inflatable restraining element can transfer a force in the forward-backward-direction, such that it can hold the front part substantially in its initial place even when hit by the person to be protected, especially by the head of this person.

Since this non-inflatable restraining element should not interfere with the head of the person to be protected, it is of the preferred that the non-inflatable retraining element extends from the upper end of the front part to the upper end of the side part. This additionally makes the manufacturing process easy and ensures a reliable and reproducible deployment behavior.

The non-inflatable restraining element has only one task, namely to restrain the front part and for this reason it is preferably as simple and light-weight as possible. Thus, in a preferred embodiment, it is a flat element, preferably a flat fabric element.

The force acting on the connection sections can be relatively high and for this reason it is often preferred that the restraining element is essentially triangle- or trapezoid shaped with the front connection section of the restraining element extending along at least half of the length of the front part between its outer end and its inner end.

Typical frontal airbags are relatively soft due to strong ventilation and the person is decelerated while diving into the frontal airbag under energy dissipation. In contrast, a combined side-front-airbag according to the invention is often not ventilated and thus relatively hard. In order to compensate for that, it can be preferred that the non-inflatable restraining element comprises at least one fold between the front connection section and the rear connection section that is initially held by a tear connection, for example in form of at least one tear seam. The tear connection tears (under dissipation of energy) when the tension in the restraining element exceeds a pre-defined value, such that the distance between the first connection section and the second connection section increases and the front part can be displaced in a controlled manner such that a too hard impact of the person (especially its head) is prevented. This fold can be simply U-shaped with two legs being connected by the tear connection.

In an especially preferred embodiment, the restraining device is designed such that it can sufficiently protect an unbelted passenger. For this reason, the airbag of the restraining device further comprises a shoulder part extending along an inner surface of the side part in such a way that it further extends over a shoulder of the person to be protected, wherein in some embodiments, this shoulder part further extends along at least a part of the thorax of the person to be protected. This shoulder part encloses a shoulder chamber that is in fluid communication to at least one of the side chamber and the front chamber. Preferably, this shoulder part is connected to both, the side part and the front part, such that it additionally contributes to the restraint of the front part in case that it is hit by the person. Especially in this configuration, the restraining device is suitable for a vehicle seat whose position and/or orientation can be changed, which might often be the case with autonomously driving cars.

In the just described case, it is further preferred to provide a first belt extending from a first end being connected to the seatback to a second end being connected to the seating in order to provide a restraint for the airbag. This first belt is preferably attached to the shoulder part and in some embodiments it is preferred that it extends through a tunnel in the front part. This gives an additional restraint for the front part and opens the possibility to design the front part with a large height.

Especially in cases in which the orientation of the vehicle seat can be chosen, it can be preferred that the seat unit comprises two restraining assemblies, one being arranged on the left side of the vehicle seat and the other being located on the right side of the vehicle seat.

The invention will now be described in detail by means of preferred embodiments in view of the figures. The figures show:

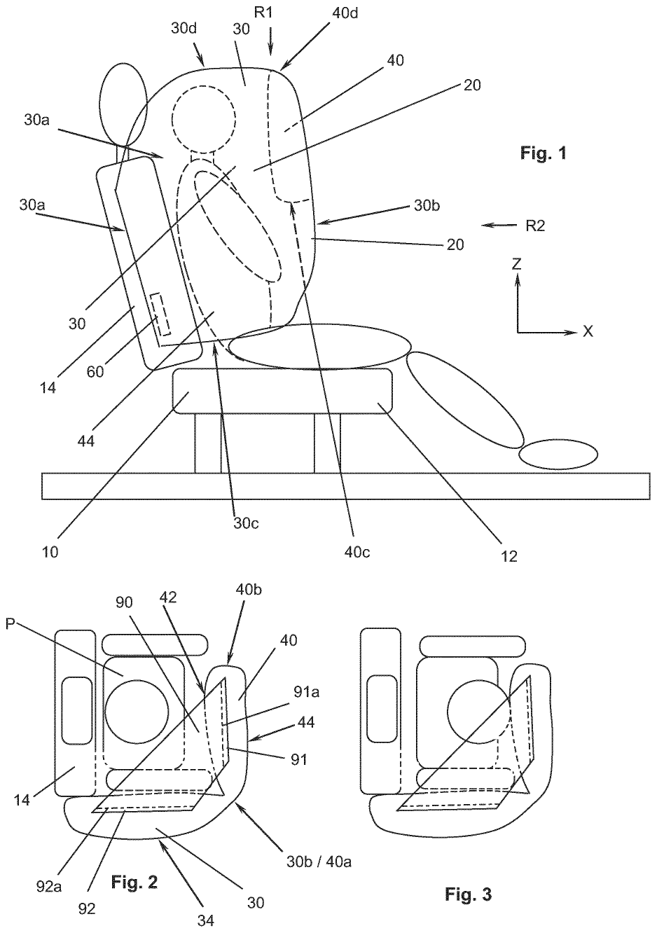

FIG. 1 a schematic side view onto a seat unit comprising a vehicle seat and a restraining device with the airbag of this restraining device being in a fully deployed state and therein a person is sitting in the vehicle seat,

FIG. 2 the items shown in FIG. 1 in a view from direction R1 in FIG. 1, but with the legs of the person and the seating not being shown,

FIG. 3 the item is shown in FIG. 2 after the head and thorax of the person have moved forward relative to the airbag and the head has hit the impact surface of the front part,

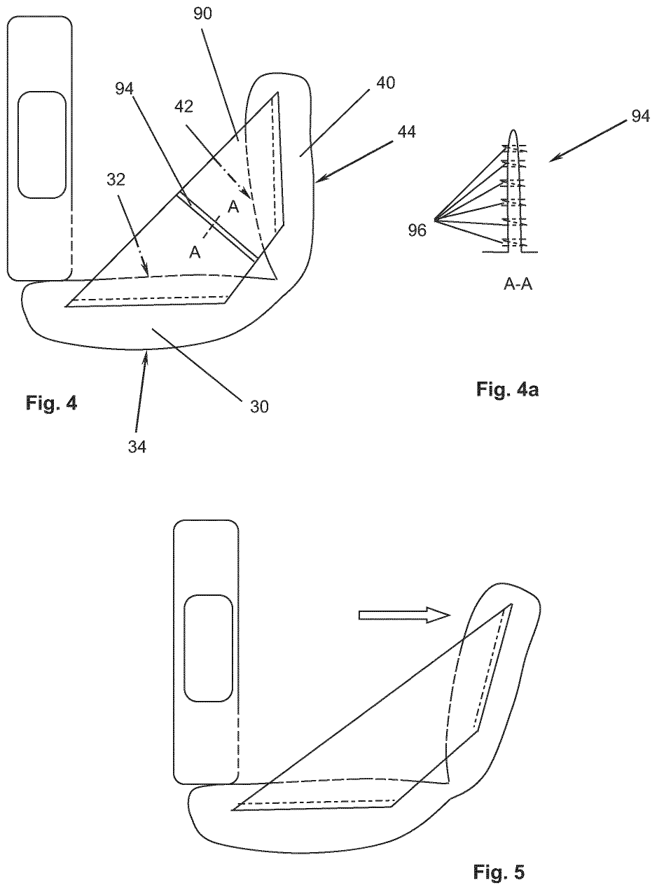

FIG. 4 a variation to the embodiment shown in FIGS. 1 to 3 in a representation according to FIG. 2 but without the person being shown,

FIG. 4a a sectional view taken plane A-A in FIG. 4,

FIG. 5 the items shown in FIG. 4 after a force in the direction of the arrow in FIG. 5 has been applied to the impact surface of the front part,

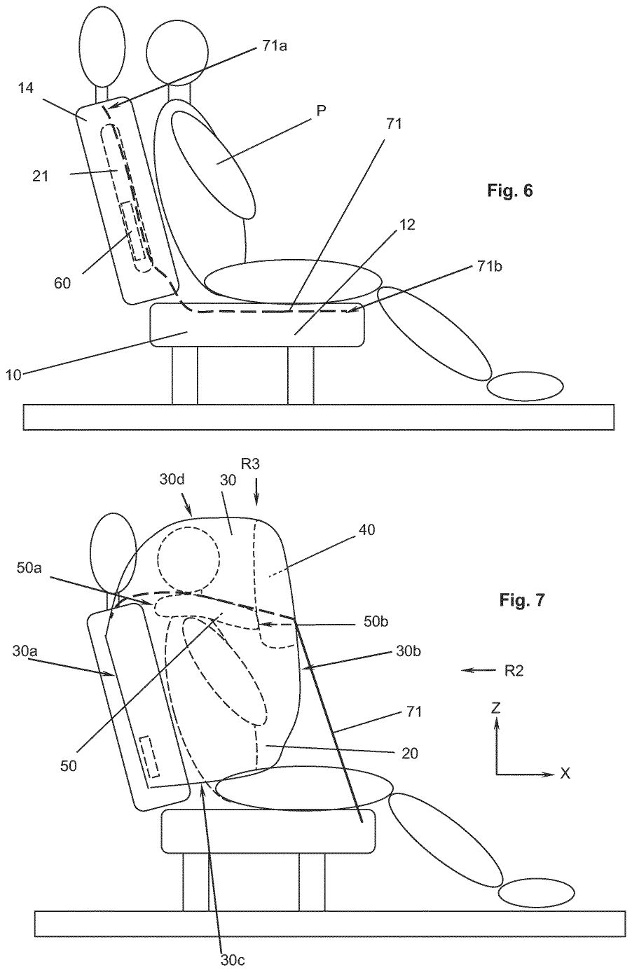

FIG. 6 a second embodiment of the invention in a state, in which the airbag of the restraining device is not deployed,

FIG. 7 the items shown in FIG. 6 in a state in which the airbag is fully deployed (according to FIG. 1),

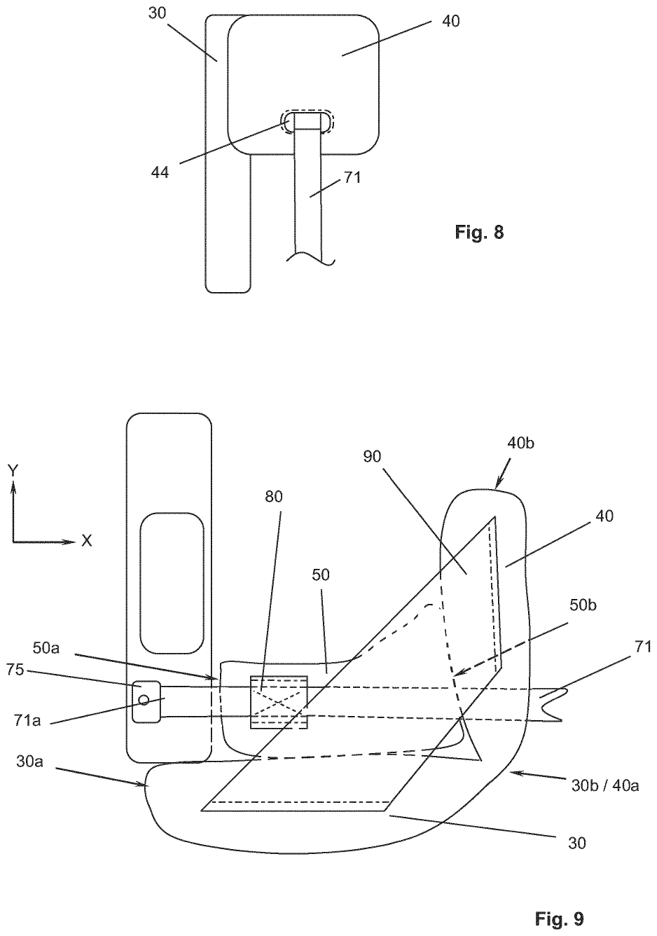

FIG. 8 a view onto some items of FIG. 7, in a view from direction R2 in FIG. 7,

FIG. 9 the items shown in FIG. 7 in a view from direction R3 in FIG. 7 but with the person and the seating not being shown,

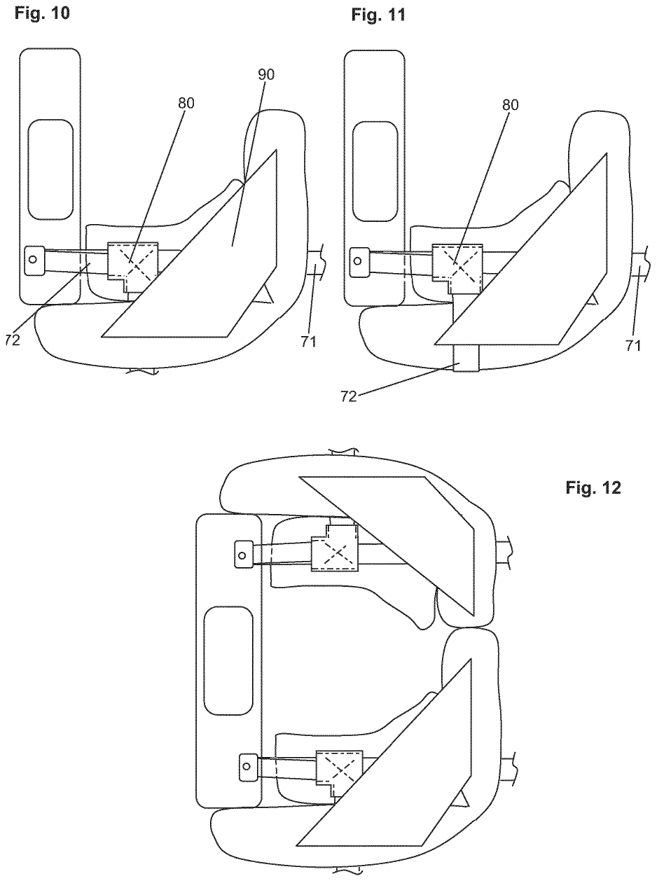

FIG. 10 a variation to what is shown in FIG. 9,

FIG. 11 a further variation to what is shown in FIG. 9,

FIG. 12 a seat unit with two restraining devices being arranged on the right and left side of the vehicle seat,

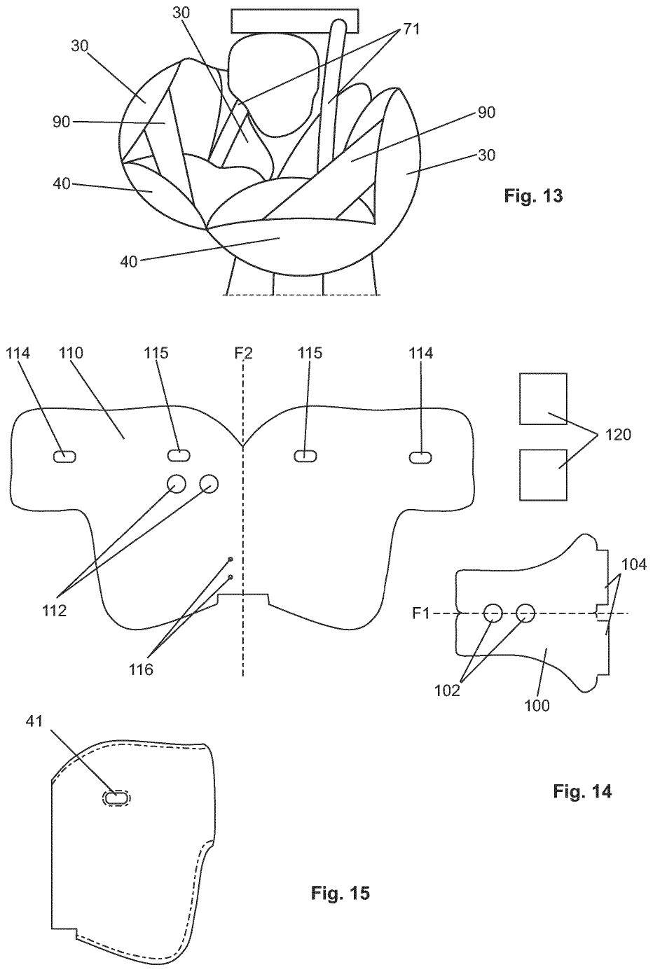

FIG. 13 another embodiment with two restraining devices,

FIG. 14 the cuttings necessary for forming an airbag as it is for example shown in FIG. 7, and

FIG. 15 the complete airbag being sewn form the cutting shown in FIG. 14 in a view from the side.

Prior to the description of the preferred embodiments, the following definitions which are chosen for this description and the whole patent application need to be defined:

In order to describe the invention with easy to understand terms, the terms “front” and “rear” are used in the description as well as in the claims. These terms refer to the vehicle seat as such in the sense that the seatback forms the rear of the vehicle seat and the seating extends from the seatback to the front end. In some vehicles, or in some configurations of a vehicle, it might be the case that the vehicle seat is orientated in such a way that the seating extends from the seatback to the rear of the vehicle or in a lateral direction, such that the terms “front” and “rear” does not necessarily refer to the orientation relative to the vehicle, only relative to the vehicle seat in the sense as described above. In this way, the front part of the airbag as will be described later on, always faces the seatback (when the airbag is in its deployed state) and a passenger, especially the head of the passenger, when seated in the vehicle seat, but in terms of the vehicle traveling direction it might not be in front. Similarly, the terms “left” and “right” are to be understood in a way that the left side of the vehicle seat is the side on which the left side (for example the left arm) of a person sitting in the vehicle seat is positioned, and the right side of a vehicle seat is the side on which the right side of a passenger is positioned.

FIGS. 1 to 3 show a first embodiment of a seat unit according to the invention. The seat unit comprises a vehicle seat 10 having a seating 12 and a seatback 14. Further, a headrest extends from the seatback as is common in the prior art. Of course, the headrest could also be integral with the seatback. Further, a restraining assembly is provided which in this first embodiment comprises a restraining device in form of an airbag 20 and an inflator 60. FIGS. 1 to 3 show the airbag 20 in its fully deployed state.

In this first embodiment, the airbag 20 is comprised of two parts, namely a side part 30 enclosing a side chamber and a front part 40 enclosing a front chamber. The side part 30 is substantially in the form of a traditional side airbag extending from a rear end 40a to a front end 40b and from a lower end 40c to an upper end 40d. The side part 30 is of a large size, such that it covers (viewed from the side) substantially the whole thorax and head of a standard sized person P sitting in the vehicle seat 10. This means that the upper end 40d is positioned at the height of the headrest or higher. The inflator 60 is attached to the frame of the seatback 14 and is located inside the side part 30 as is common with side airbags.

A front part 30 of the airbag 20 extends from the front end 40b of the side part substantially parallel to the seatback 14, such that it is located substantially in front of the head and in this embodiment also the upper thorax of the person P. So, the front part 30 extends from and outer end 40a (which coincides with the front end 30b of the side part) to an inner end 40b and from a lower end 40c of the front part to an upper end 40d of this front part 40.

As can especially be seen from FIG. 2, a non-inflatable restraining element 90, which is because of its shape also referred to as “sail” extends from the front part 40 to the side part 30. In the embodiment shown and this is generally preferred, this non-inflatable restraining element 90 extends from the upper end 40d of the front part to the upper end 30d of the side part. This non-inflatable restraining element 90 is preferably a fabric element and can especially be made from standard airbag material. It is usually sufficient that it is single-layered. This non-inflatable restraining element 90 is connected to the front part 40 via a first connection section 91 of the non-inflatable restraining element and to the side part 30 via a second connection section 92 of the non-inflatable restraining element. In the embodiment shown, and this is often preferred, those connection sections 91 and 92 also constitute end sections of the non-inflatable restraining element 90 since there is most often no need that the non-inflatable restraining element 90 extends beyond the connection sections 91 and 92, although this would of course be possible. The first connection 91 is connected to the front part 40 by means of a first connection 91a, which can be in form of a first seam. In the same way, the second connection section 92 is connected to the upper end 40d of the side part by means of a second connection 91a which can be in form of a second seam. It is preferred that the first connection section and thus the first connection extend along a substantial length of the front part 40, namely at least half of the distance between the outer end 40a to the inner end 40b. Similarly it is preferred that the second connection section 92 extends along a substantial length of the side part 30 between its rear end 30a and its front end 30b. The two connections each define a direction and these two directions are substantially perpendicular to one another.

The effect of this non-inflatable restraining element 90 can directly be seen from FIG. 3 showing the situation after the person P, especially its head, has hit the inner surface 42 (the impact surface) of the front part 40: Due to the non-inflatable restraining element 90, the front part cannot substantially swerve, such that it restrains the person P, especially its head.

FIGS. 4, 4a and 5 show a variant to what has just been described. The general setup is as described in view of FIGS. 1 to 3, but the non-inflatable restraining element 90 shows an additional feature, namely a fold 94, which is secured to itself by means of tear seams 96. In this embodiment, the fold 94 is a simple fold with a U-shaped cross section, but it would also be possible to provide a fold with a more complex shape. The fold is positioned in a middle section between the first connection section 91 and the second connection 92 and extends in a transverse direction meaning that it does not connect the first connection section to the second connection section, such that the fold shortens the distance between the connection sections 91 and 92.

When a force in direction of the arrow shown in FIG. 5 is applied to the impact surface 42 of the front part 40, which exceeds a pre-defined value, the tear seams 96 tear such that the non-inflatable restraining element 90 transits to its original length and the front part 40 is rotated around its connection to the side part by a defined angle. This simulates to some extend the behavior of a traditional frontal airbag which is usually relatively soft due its strong ventilation. This means that some of the kinetic energy of the person P is dissipated and the force peaks are reduced.

FIG. 6 to 9 show a second embodiment. The main difference to the first embodiment is that the restraining device further comprises a first belt 71 and that the airbag of the restraining device further comprises a shoulder part 50. By this measure a fully self-restraining safety device is provided, which especially makes it possible that the passenger does not necessarily have to wear a seat belt.

FIG. 6 shows the seat unit in a state in which the airbag 20 of the restraining device is not deployed. The packed airbag 21 is located inside or along the seatback 14 and the first belt 71 extends from a first end 71a which is attached to the seatback to a second end 71b which is attached to a forward end of the seating 12. This first belt 71 is attached to the before mentioned shoulder part 50 of the airbag 20 as will be described later, especially in view of FIG. 9, and extends through a tunnel 44 in the front part 40, as can especially be seen from FIG. 8. The structure of the restraining device—and especially its airbag—of the second embodiment can best be seen in FIGS. 7 and 9: The side part 30 of the airbag 20, the front part 40 of the airbag 20 and the non-inflatable restraining element 90 are arranged as in the first embodiment, such that full reference can be made to this embodiment. Although not shown in FIG. 9, it would of course be possible that the non-inflatable restraining element 90 of this second embodiment also shows a fold being secured by tear seam or another tearable connection. The shoulder part 50 is connected to the inner surface 42 (the impact surface) of the front part and to the inner surface 42 (also the impact surface) of the side part 30. Further, the shoulder chamber enclosed by the shoulder part 50 is in flow communication to at least one of the front chamber and the side chamber. In the embodiment shown, the connection of the shoulder part 50—namely its upper surface—to the first belt 71 is created by means of a load bearing patch 80. The function of the non-inflatable restraining element 90 is the same as in the first embodiment: It hinders the front part 40 from tilting away when hit by the head of the person P.

FIG. 10 shows a third embodiment. This embodiment comprises additionally a second belt 72 whose first end 72a is also attached to the backrest 14, preferably at the upper end of the backrest 14; the first belt 71 and the second belt 72 can use the same bracket 75 for this attachment. The second belt 72 is also attached to the upper surface of the shoulder part 50 and a joint load bearing patch 80′ can be used for this as it is shown in FIG. 10. In contrast to the first belt 71, the second belt 72 does not extend through the first tunnel 51 but through a second tunnel 41 in the side part 30. The second end of the second belt 72 is also attached to the seat, especially in a region of the seating 12, such that a lower section of the second belt 72 extends along the outer surface of the lower section of the side part 30, such that the second belt 72 prevents the airbag cushion and especially its side part 40 from moving in the -Y-direction even if no supporting surface (like an inner structure of the vehicle, for example a door) is provided, such that the occupant is restrained also in this direction. So, in this embodiment the restraining device is fully self-supporting and does not need any supporting surfaces.

As an alternative, the second belt 72a could extend over the upper end 30d of the side part 30, such that a section of the second belt extends along the whole height of the outer wall of this side part 30. This alternative (in a view according to FIG. 10) is shown in FIG. 11.

FIG. 12 shows a third embodiment in a representation according to FIG. 9. Here, two restraining assemblies are provided, one on the right side of the vehicle seat and one on the left side of the vehicle seat. In principle these two restraining devices could be mirror-symmetrical, but it will often be preferred that they are not mirror-symmetrical. Especially one of the front parts can be larger than the other front part, such that the border between those two front parts is offset from the middle axis of the vehicle seat. By that measure, the front restraining function is taken over mainly by one of the two restraining devices, such that the head of the occupant cannot slip through the two front parts, even if they are allowed to pivot due to the presence of a fold in the non-inflatable restraining elements as has been described above.

As can be seen from FIG. 13, such a “doubling” of the restraining devices can also be applied to the case that each restraining device comprises only one belt. Providing one restraining device with one belt and the other restraining device with two belts would of course also be possible.

As has been mentioned, a fold with a tear-connection could be applied to every non-inflatable restraining element shown in FIGS. 6 to 13 although not being shown in those Figures.

FIG. 14 shows schematically an example for the cuttings being necessary in order to manufacture the airbag of the second embodiment. In FIG. 14 only strictly necessary cuttings are shown, but of course additional cuttings, for example for forming enforcement layers, inner tethers or the like can be used, but since those are not necessary in order to understand the structure, they are not shown. Further, outer tethers or other outer elements could be used, for example in form of at least one sail connecting at least two of the parts in order to provide an additional restraining element. In the embodiment shown, only four cuttings are necessary, namely a first cutting 100 for the shoulder part, a second cutting 110 for the side part and the front part, and cuttings 120 for the tunnel walls. Both, the first cutting 100 and the second cutting 110 are of the “butterfly” type, meaning that they are folded along a folding line F1 and F2 respectively. Of course, this invention is not limited to the type of cuttings shown here. For example, each layer could be made from a distinct cutting. Further, providing a joint cutting for layers of the first part and third part is not mandatory.

The first cutting 100 shows at least one overflow opening 102 (here two overflow openings) and the second cutting 110 shows matching overflow openings 112. Additionally, the second cutting 110 shows two holes 114 for the first tunnel and two holes 115 for the second tunnel. Further, holes 116 for inflator studs are provided as is generally known form side airbags.

The sewing process could for example be as follows: First, the first cutting 100 is sewn to the second cutting 110, especially around the overflow openings 102, 112. After this, the first cutting 100 can be folded and closed by an edge seam in order to form the shoulder part. Then, the cuttings 120 for the tunnel walls can be sewn to the edges of their respective holes 114, 115 and then the shoulder part can be sewn to the cutting 110 by means of protruding sections 104 of the first cutting 100. Finally, an edge seam for closing the cutting 110 to form the side part and the front part can be applied. Because the shoulder part is connected to both, the side part and the front part, the front part is automatically bent out of the plane of the side part, such that the completely sewn airbag looks as it is shown for example in FIG. 9.

### LIST OF REFERENCE NUMBERS

10 vehicle seat
12 seating
14 seatback
20 airbag
21 packed airbag
30 side part
30a rear end of side part
30b front end of side part
30c lower end of side part
30d upper end of side part
32 inner surface (impact surface)
34 outer surface
36 (fabric) element for fastening belt(s) to first part
40 front part
40a outer end of front part
40b inner end of front part
40c lower end of front part
40d upper end of front part
42 inner surface (impact surface)
44 outer surface
44 tunnel through front part
50 shoulder part
50a rear end of shoulder part
50b front end of shoulder part
60 inflator
71 first belt
71a first end (attached to seatback)
71b second end (attached to seating)
72 second belt
72a first end (attached to seatback)
75 bracket
80 load bearing patch
90 non-inflatable restraining element (sail)
91 first connection section
91a first connection (first seam)
92 second connection section
91a second connection (second seam)
94 fold
96 tear seam
100 cutting for first part
102 overflow opening
104 protruding section for sewing to third part
110 cutting for second and third part
112 overflow opening
114 hole for first tunnel
115 hole for second tunnel
116 hole for inflator stud
120 cutting for tunnel wall
130 shaping element
130a first (inner) section
130b second section
132 hole for inflator stud
134 connection (sewing)/position of sewing
134a, b sections of connection
136 closing seam
FL1, FL2 folding line
P person

1. A restraining device of a seat unit, said seat unit further comprising a vehicle seat which comprises a seatback defining the rear end of the vehicle seat and a seating extending from the seatback to a front end of the vehicle seat, wherein
said restraining device comprises an airbag having a side part enclosing a side chamber and being attached to the seatback, and a front part enclosing a front chamber and being attached to the side part, wherein the front chamber is in fluid communication with the side chamber and
wherein, in the deployed state of the airbag, the side part extends from a rear end of the side part being attached to the seatback to a front end of the side part and from a lower end of the side part to an upper end of the side part, and
the front part extends from an outer end of the front part being connected to the side part to an inner end of the front part, and from a lower end of the front part to an upper end of the front part,
wherein a non-inflatable retraining element extends from a first connection section being connected to the front part of the airbag to a second connection section being connected to at least one of the vehicle seat and a part of the restraining device located rear of the front part when the airbag is in its deployed state.

2. The restraining device of claim 1, wherein the non-inflatable retraining element extends from the upper end of the front part to the upper end of the side part.

3. The restraining device of claim 1, wherein the non-inflatable restraining element is a flat element, preferably a flat fabric element.

4. The restraining device of claim 3, wherein the non-inflatable restraining element is essentially triangle-shaped or trapezoid-shaped with the first connection section of the restraining element extending along at least half of the length of the front part between its outer end and its inner end.

5. The restraining device of claim 1, wherein the non-inflatable restraining element comprises at least one fold between the first connection section and the second connection section, said fold being initially held by a tear connection, which is preferably in form of at least one tear seam, wherein said tear connection tears when the tension in the non-inflatable restraining element exceeds a pre-defined value, such that the distance between the first connection section and the second connection section increases.

6. The restraining device of claim 4, wherein the fold is U-shaped with two legs being connected by the tear connection.

7. The restraining device of claim 1, wherein the airbag further comprises a shoulder part extending along an inner surface of the side part.

8. The restraining device of claim 1, wherein it further comprises a first belt extending from a first end being connected to the seatback to a second end being connected to the seating.

9. The restraining device of claim 8, wherein the first belt extends through a tunnel in the front part.

10. The restraining device of claim 7, further comprising a first belt extending from a first end being connected to the seatback to a second end being connected to the seating, said first belt being attached to the shoulder part.

11. A restraining assembly comprising the restraining device of claim 1, according and an inflator being in fluid communication with the side part of the airbag.

12. A seat unit comprising a vehicle seat and at least one restraining assembly according to claim 11, such that the rear end of the side part of the airbag of this at least one restraining assembly is attached to the seatback of the vehicle seat at least indirectly.

13. The seat unit according to claim 12, wherein the seat unit comprises two restraining assemblies, one being arranged on the left side of the vehicle seat and the other being located on the right side of the vehicle seat.
